(19) United States
(12) Patent Application Publication
(10) Pub. No.: US 2014/0067902 A1
(43) Pub. Date: Mar. 6, 2014

(54) METHOD AND APPARATUS FOR USING MULTIPLE UNIVERSAL RESOURCE IDENTIFIERS IN M2M COMMUNICATIONS

(71) Applicant: INTERDIGITAL PATENT HOLDINGS, INC., Wilmington, DE (US)

(72) Inventors: Chonggang Wang, Princeton, NJ (US); Dale N. Seed, Allentown, PA (US); Lijun Dong, San Diego, CA (US); Guang Lu, Montreal (CA); Michael F. Starsinic, Newtown, PA (US); Nicholas J. Podias, Brooklyn, NY (US); Quang Ly, North Wales, PA (US); William R. Flynn, IV, Schwenksville, PA (US); Zongrui Ding, San Diego, CA (US); Paul L. Russell, JR., Pennington, NJ (US); Qing Li, Princeton Junction, NJ (US)

(73) Assignee: INTERDIGITAL PATENT HOLDINGS, INC., Wilmington, DE (US)

(21) Appl. No.: 14/014,801

(22) Filed: Aug. 30, 2013

Related U.S. Application Data
(60) Provisional application No. 61/696,655, filed on Sep. 4, 2012.

(51) Int. Cl. H04L 29/08

(52) U.S. Cl. CPC H04L 67/16
USPC 709/201

(57) ABSTRACT

A method and apparatus may use multiple URIs (MU) in a single request message for machine-to-machine (M2M) communication networks. Multiple single URI (SU)-type request messages may be received from an application client (e.g. a constrained application protocol (CoAP)/hypertext transfer protocol (HTTP) client) at a (CoAP/HTTP) intermediary node. The multiple SU-type request messages may be aggregated into a single MU-type request message at the intermediary node, and the single MU-type request message may be transmitted to a (CoAP/HTTP) server. A multiple value (MV)-type response message may be received from the (CoAP/HTTP) server. The MV-type response message may be deaggregated into multiple single value (SV)-type response messages. The multiple SV-type response messages may be transmitted to the (CoAP/HTTP) client.

### CROSS REFERENCE TO RELATED APPLICATIONS

This application claims the benefit of U.S. provisional application No. 61/696,655, filed Sep. 4, 2012, the contents of which are hereby incorporated by reference herein.

### BACKGROUND

In application protocols such as Constrained Application Protocol (CoAP) and Hypertext Transfer Protocol (HTTP), resources may be accessed in a Representational State Transfer (REST)ful manner. SUCH RESTful methods may include CREATE, RETRIEVE, UPDATE, and DELETE. Each resource may have a unique universal resource identifier (URI) and may be addressed via this URI based on Request/Response or Client/Server model. A request message (e.g. a CoAP or HTTP request message) may contain one URI to operate on a single resource. In order to access multiple resources, multiple request messages may be issued.

In the context of Machine-to-Machine (M2M) scenarios where many M2M devices may be resource-constrained, an M2M device may have multiple resources such as different types of sensors and actuators. Moreover, an M2M application may operate (e.g. GET/POST/PUT/DELETE) on multiple different resources simultaneously. In these example scenarios, limiting one URI in a request message may generate multiple different CoAP/HTTP request messages and cause unnecessary communication burden and overhead. In another example, multiple M2M applications may operate on the same M2M device, but different resources, which may inevitably lead to multiple CoAP/HTTP request messages being sent.

### SUMMARY

A method and apparatus may use multiple unique universal resource identifiers (URIs) in a single request message for machine-to-machine (M2M) communications. An M2M device may receive a multiple URI (MU)-type request message including a multiple URIs associated with a multiple corresponding resources at the M2M device. The M2M device may decode each of the URIs, and may generate at least one multiple value (MV)-type response message including a multiple values in a payload corresponding to the resources at the M2M device. An M2M application may generate an MU-type request message to access resources at an M2M device, and include multiple URIs corresponding to resources at the M2M device. The M2M application may transmit the MU-type request message to the M2M device, possibly via an intermediary such as an M2M core or gateway. The M2M application may receive at least one MV-type response message, from the M2M device, including a multiple values in a payload corresponding to the plurality of resources.

An M2M intermediary may receive multiple single URI (SU)-type request messages from an M2M client. The M2M intermediary may aggregate the SU-type request messages to generate an MU-type request message including multiple URIs extracted from the SU-type request messages, and may transmit the MU-type request message to a M2M server. The M2M intermediary may receive a multiple MV-type response message from the M2M server, including multiple values in a payload corresponding to the plurality of resources. The M2M intermediary may deaggregate the MV-type response message and generate a plurality of SV-type response messages, each including a value from the plurality of values corresponding to a different resource. The M2M intermediary may transmit the SV-type response messages to the M2M client.

A method and apparatus may use multiple URIs (MU) in a single request message for M2M communication networks. Multiple single URI (SU)-type request messages may be received from an application client (e.g. a constrained application protocol (CoAP)/hypertext transfer protocol (HTTP) client) at a (CoAP/HTTP) intermediary node. The multiple SU-type request messages may be aggregated into a single MU-type request message at the intermediary node, and the single MU-type request message may be transmitted to a (CoAP/HTTP) server. A multiple value (MV)-type response message may be received from the (CoAP/HTTP) server. The MV-type response message may be deaggregated into multiple single value (SV)-type response messages. The multiple SV-type response messages may be transmitted to the (CoAP/HTTP) client.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is an example of an M2M network with CoAP/HTTP request messages using a single universal resource identifier (URI) (SU) approach;

FIG. 3 is an example of an M2M network with CoAP/HTTP request messages using a multiple URI (MU) approach;

FIG. 4 is an example of an M2M architecture employing MU procedures;

FIG. 5 shows an example of an M2M architecture employing multiple URI (MU) request deaggregation and single value (SV) response aggregation at a CoAP/HTTP intermediary;

FIG. 6 shows an example of an M2M architecture employing SU request aggregation and multiple value (MV) response deaggregation at a CoAP/HTTP Intermediary.

FIG. 7 shows a flow diagram for a procedure for handling multiple URIs at a server;

FIG. 8 shows a flow diagram for a procedure for handling multiple URIs at an intermediary;

FIG. 9 shows an example of a CoAP/HTTP protocol stack including MU integration;

FIG. 10 shows an example of an MU-type CoAP request message in an MU first format;

FIG. 11 is an example MU-type CoAP request message in an MU second format;

FIG. 12 shows an example of an MV-type CoAP response message in an MU first format;

FIG. 13 shows an example of an MV-type CoAP response message in an MU second format;

FIG. 14 shows an example of an SV-type CoAP response message 1400 generated from an MU-type request message;

FIG. 15A shows an example of a standard format of an MU option;

FIG. 15B shows an example of a compact format of an MU option;

FIG. 16 is an example of an M2M architecture where both the CoAP/HTTP client(s) and server support MU;

FIG. 17 is an example of an M2M architecture where the CoAP/HTTP client(s) supports MU and CoAP/HTTP server does not support MU, employing an CoAP/HTTP Intermediary;

FIG. 18 is an example of an M2M architecture where the CoAP/HTTP client(s) does not support MU and the CoAP/HTTP server supports MU, employing an CoAP/HTTP Intermediary; and

FIGS. 19 and 20 show transmission utility values versus number of URIs for 802.15.4 and 802.11 networks, respectively.

### DETAILED DESCRIPTION

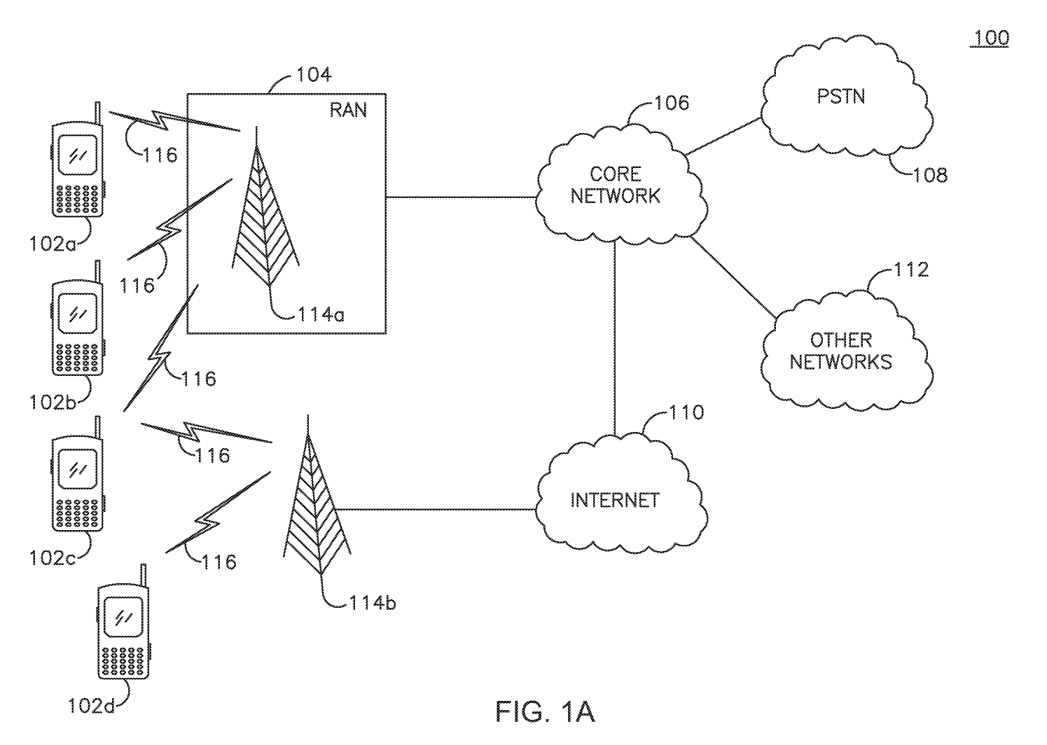

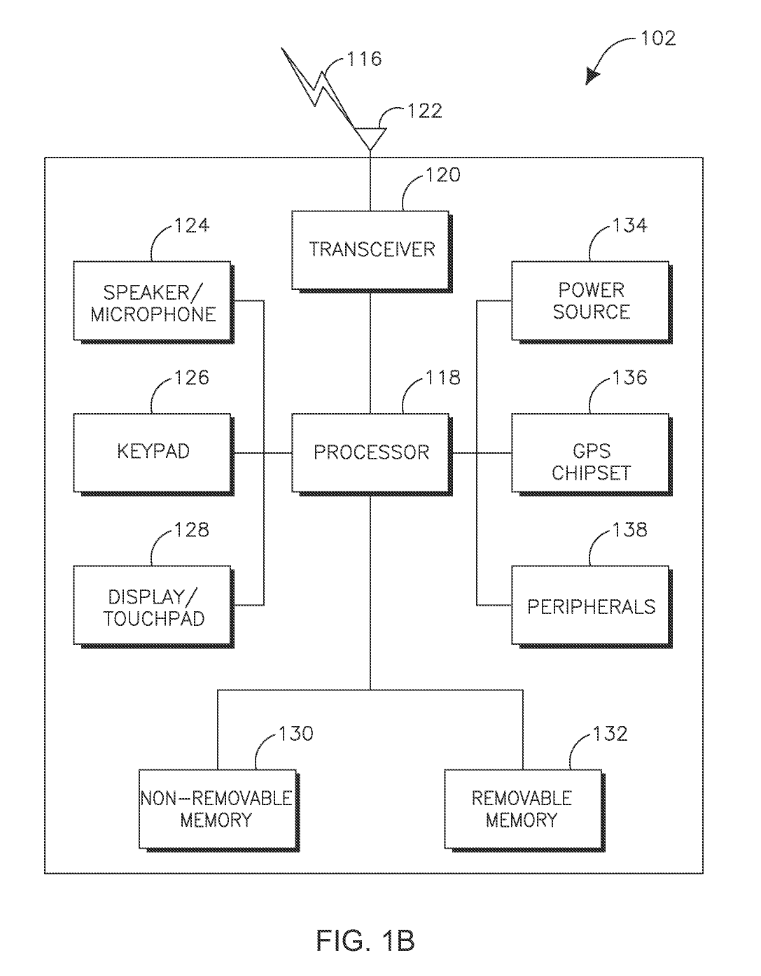

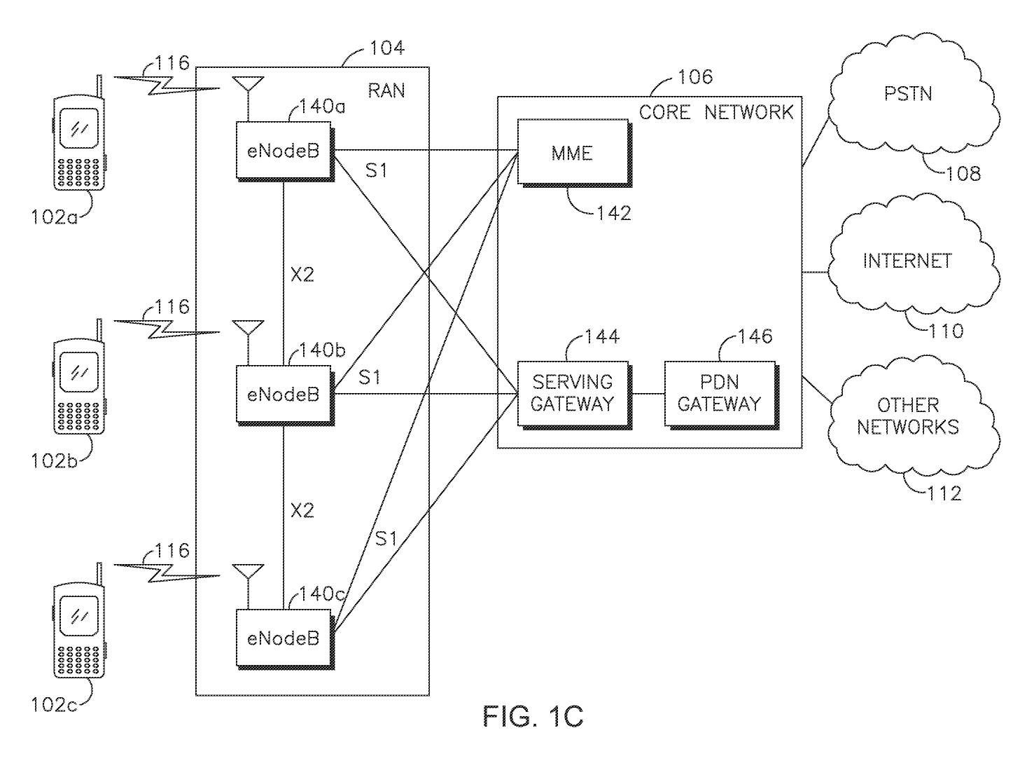

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

In the following, architecture and procedures may embed multiple URIs in CoAP/HTTP messages. Architecture and procedures may aggregate and de-aggregate messages based on multiple URIs. Techniques may implement multiple URIs in CoAP and/or HTTP. Methods may interwork multiple URI CoAP/HTTP and single URI CoAP/HTTP.

The embodiments are described herein with respect to the Constrained Application Protocol (CoAP) and/or Hypertext Transfer Protocol (HTTP) for illustrative purposes. For example, techniques are described with respect to HTTP/CoAP request messages, and HTTP/CoAP clients, HTTP/CoAP servers and HTTP/CoAP intermediaries. However, the disclosed techniques may be used for any type of protocol used to access resources including other Representational State Transfer (REST)ful based protocols including, for example, Message Queue Telemetry Transport (MQTT).

In an example, HTTP may be designed as a Request/Response-based protocol for users to access the Internet. Each HTTP request message may contain a single URI to identify the requested resource, which may be sufficient for accessing Internet from computers and laptops. In the case of M2M communications, there may be many constrained devices connected by constrained networks such as IEEE 802.15.4-based sensor networks or M2M Area Networks. M2M communications may involve large amounts of data transmission from constrained devices to networks for purposes such as data collection. In another example, CoAP may be designed to cater to such constrained devices and networks in M2M communications. CoAP may adopt optimization techniques to make it lightweight and energy-efficient. However, CoAP may be designed to use one single URI in each request message, which may introduce significant overhead for M2M constrained devices and networks.

In another example, HTTP may be used to provide web services for business-to-business (B2B) transactions that may generate large amounts of data for transmission, similar to M2M scenarios. However, there may only be one URI in the request message, which may similarly cause significant overhead and inefficiencies.

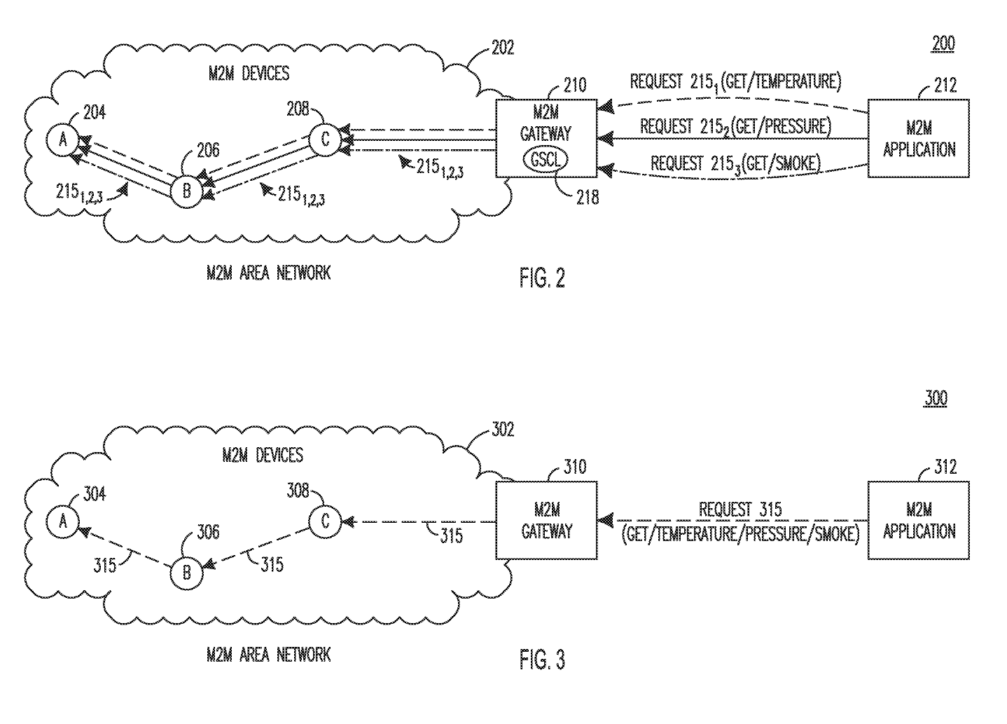

FIG. 2 is an example of an M2M network 200 with CoAP/HTTP request messages using a single universal resource identifier (URI) (SU) approach. The SU approach refers to each request containing only one URI. The example M2M network 200 may include an M2M area network 202 including M2M devices 204, 206, and 208. The M2M devices 204, 206 and 208 may communicate with M2M application 212 via an M2M gateway 210. The M2M application 212 may reside, for example, on a client device (not shown). FIGS. 2 and 3 are exemplary instances of an M2M network, such that any number of M2M devices, gateways, applications and other devices and entities although not shown may be part of the network. Examples of M2M devices include sensors (e.g. temperature, humidity, barometric pressure, water meters, etc.) and actuators (e.g. light switches, thermostats, etc.). M2M applications may reside on, for example, user devices such as phones, tablets, and personal computers (PCs), or any other device.

By way of example, M2M device 204 may have three resources. For example, these resources may be identified temperature, pressure, and smoke, respectively. According to an SU approach, M2M application 212 may transmit three separate request messages 215_{1,2,3} to operate the three resources. For example, request 215₁ may be for temperature, request message 215₂ may be for pressure and request message 215₃ may be for smoke. In total, the M2M application may transmit three request messages 215_{1,2,3} in order to manipulate the 3 resources although they are on the same M2M device 204 when the SU approach is used in CoAP/HTTP. It may be that the M2M device 204 did not create the locally generated resources on its local service capability layer (SCL) 218, which may be a gateway SCL (GSCL) 218 of the M2M Gateway 210.

The SU approach, as shown in FIG. 2, may have large overhead at the M2M end device 204. M2M device 204 may receive and process three separate request messages 215_{1,2,3} and transmit back three separate responses (not shown) to the M2M application 212. The SU approach may also have large overhead within the M2M area network 202. As shown in FIG. 2, the three request messages 215_{1,2,3} may traverse the M2M area network 202, such that intermediate devices 206 and 208 may forward the three request messages 215_{1,2,3} and the corresponding responses (not shown) on the reverse path.

According to an embodiment, multiple URIs may be included in a single request message, for example for CoAP and HTTP protocols, referred to as a Multiple URIs (MU) approach. An MU approach may improve CoAP/HTTP performance in constrained M2M area networks and devices. According to the MU technique, each CoAP/HTTP request message may contain multiple URIs as needed and each URI may represent a particular resource.

An MU approach may lower protocol overhead, traffic load and congestion, have higher energy-efficiency, and produce faster response times and lower latency. For example, embedding multiple URIs in a single CoAP/HTTP request message may reduce protocol overhead caused by CoAP/HTTP, User Datagram Protocol (UDP) or Transmission Control protocol UDP/TCP, and Internet protocol (IP) or Medium Access Control (MAC) headers. It may also reduce the number of request messages and in turn lower energy consumption, particularly in multiple-hop M2M area networks, such as the example in FIG. 2. The MU approach may also mitigate traffic load in the M2M area network with less probability of congestion occurrence.

Instead of issuing multiple request messages separately to resources on the same M2M device, a single request message may contain multiple URIs to reduce the number of request messages. The following terminology is used herein, although other terminology may be used. An MU-type Request Message may be a (CoAP or HTTP) request message that contains multiple URIs. A single URI (SU)-type Request Message may be a (CoAP or HTTP) request message that contains a single URI. A multiple value (MV)-type Response Message may be a (CoAP or HTTP) response message containing multiple values in the payload. A single value (SV)-type Response Message may be a (CoAP or HTTP) response message containing a single value in the payload. Although CoAP/HTTP are used as example protocols, other the described techniques may be used in a similar manner with any protocol.

FIG. 3 is an example of an M2M network 300 with CoAP/HTTP request messages using an MU approach. The example M2M network 300 may include an M2M area network 302 including M2M devices 304, 306, and 308. The M2M devices 304, 306 and 308 may communicate with M2M application 312 via an M2M gateway 310.

By way of example, M2M device 304 may have three resources identified as temperature, pressure, and smoke. The M2M application 312 may transmit a single MU-type request message 315, which may contain three URIs associated with the three resources temperature, pressure, and smoke. In contrast to SU illustrated in FIG. 2, MU may reduce the number of required request messages.

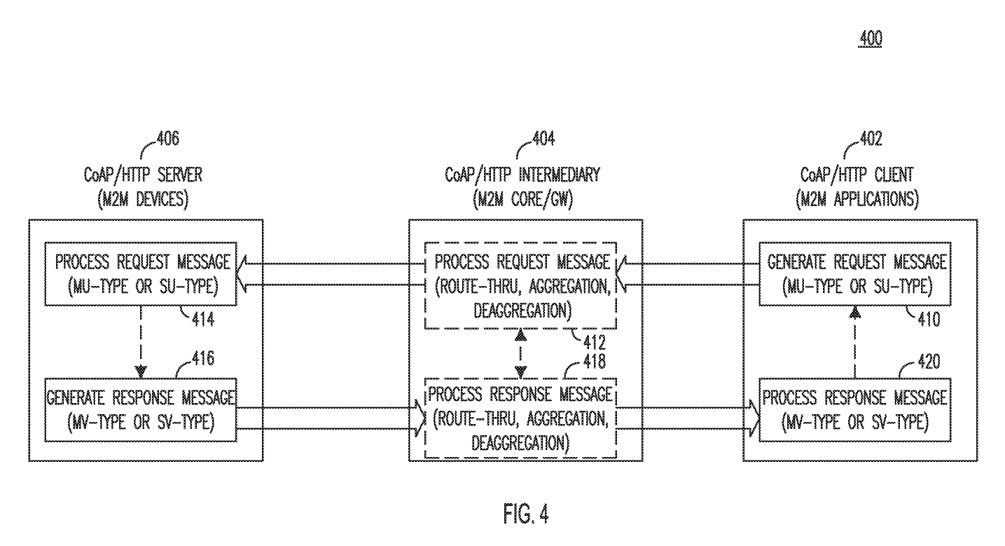

FIG. 4 shows an example of an M2M architecture 400 employing MU procedures. The M2M architecture 400 may include one or more M2M applications 402, one or more M2M core nodes or gateways (GWs) 404 and one or more M2M devices 406. The M2M architecture 400 may be, for example, represented by a CoAP/HTTP client-server model, such that the terminology is used interchangeably as follows. The M2M application(s) 402 may play the role of a CoAP/HTTP Client 402 that requests to access resources on M2M devices 406. The M2M device(s) 406 may play the role of a CoAP/HTTP Server 406 that provides resources to be accessed by the M2M application(s) 402. The M2M GW(s) or core node(s) 404 may serve as a CoAP/HTTP Intermediary 404.

For example, FIG. 4 (and similarly, any of the M2M architectures described herein) may represent, in one example, an M2M network 400 for home monitoring and automation. The servers 406 may be sensors (e.g. temperature, pressure, smoke), the client 402 may be a cellphone application operated by a user and used to monitor temperature in the home, and the intermediary 404 may be, for example, a modem or gateway.

Examples of high-level MU procedures are shown in FIG. 4 and are described with respect to each entity in the M2M architecture 400 as follows. The CoAP/HTTP client may generate request messages 410 and may process response messages 420. In 410, the CoAP/HTTP Client 402 may generate and send a request message. If there is a need to access multiple resources on a same M2M device 406, the client 402 may put multiple corresponding URIs in the request message to generate an MU-type request message. Those URIs contained in the request message may address different resources on the same M2M device 406. In 420, the CoAP/HTTP Client 402 may process a response message received from the corresponding CoAP/HTTP Server 406. Such a response message may contain multiple values in the payload, such that each value may be the response to a corresponding URI that was in the original request message.

The CoAP/HTTP server 406 may process request messages 414 and generate response messages 416. In 414, the CoAP/HTTP Server 406, after receiving an MU-type request message from CoAP/HTTP Client 402, may process the received request message and decode each URI contained therein. In 416, the CoAP/HTTP Server 406 may generate on or more response messages and may transmit the response message to the requesting CoAP/HTTP Client 402. For example, the response message may be SV-type or MV-type.

CoAP/HTTP Intermediary 404 may process request messages 412 and process response messages 418. In 412, the CoAP/HTTP Intermediary 404 may process one or more request messages, which may include aggregating multiple SU-type request messages received from the CoAP/HTTP client 402 and addressed to the same M2M device 406 into one (or more) MU-type request message. The CoAP/HTTP Intermediary 404 may similarly deaggregate an MU-type request message from the CoAP/HTTP client 402 into multiple SU-type request messages. The Intermediary 404 may aggregate SU-type request messages and generate a new MU-type request message. In 418, the Intermediary 404 may receive an MV-type response (or SV-type responses) back from the CoAP/HTTP Server 406, and may deaggregate the MV-type responses to generate separate SV-type responses for each original SU-type request. If the CoAP/HTTP Server 406 does not support MU, the Intermediary 404 may not perform SU-type request aggregation. The MU capability of the CoAP/HTTP Server 406 may be obtained through different approaches such as resource discovery. If the CoAP/HTTP Server 406 does not support MU, but the Intermediary 404 receives an MU-type request from a CoAP/HTTP Client 402 that supports MU, the Intermediary 404 may perform deaggregation. In other words, the Intermediary 404 may process the MU-type request message and generate multiple SU-type request messages to send to the CoAP/HTTP Server 406. In 418, The CoAP/HTTP Intermediary 404 may aggregate multiple SV-type response messages into one MV-type response message.

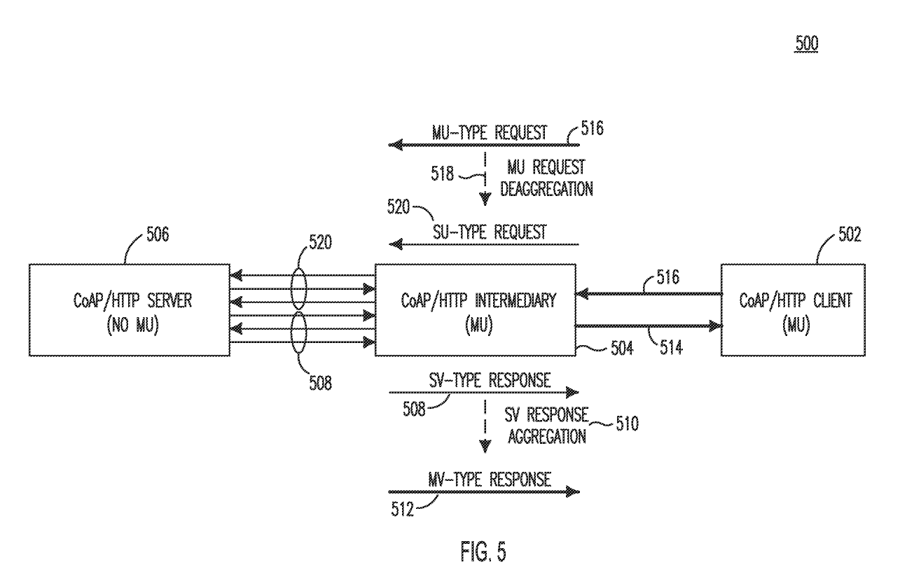

According to an embodiment, SV-type Response Aggregation may be used together with MU-type Request Deaggregation. FIG. 5 shows an example of an M2M architecture 500 employing MU request deaggregation and SV response aggregation at a CoAP/HTTP intermediary. The M2M architecture 500 may include a CoAP/HTTP client 502, a CoAP/HTTP server 506, and a CoAP/HTTP intermediary 504 that may relay messages between the client 502 and server 506. In this example, the CoAP/HTTP Client 506 may support MU, but the CoAP/HTTP Server may not support MU (i.e. it may issue only SU-type request messages).

The Intermediary 504 may receive 508 one or more SV-type responses from the Server 506, and may aggregate 510 the one or more received SV-type responses to generate 512 an MV-type response and may transmit 514 the MV-type response to the CoAP/HTTP Client 502.

If the Intermediary 504 receives 516 an MU-type request from a CoAP/HTTP Client 502 that supports MU, the Intermediary 504 may deaggregate 518 the MU Request to generate and transmit 520 one or more SU-type requests to the CoAP/HTTP server 506. In other words, the Intermediary 504 may process 518 the received MU-type request message and generate 520 multiple SU-type request messages to send to the CoAP/HTTP Server 506.

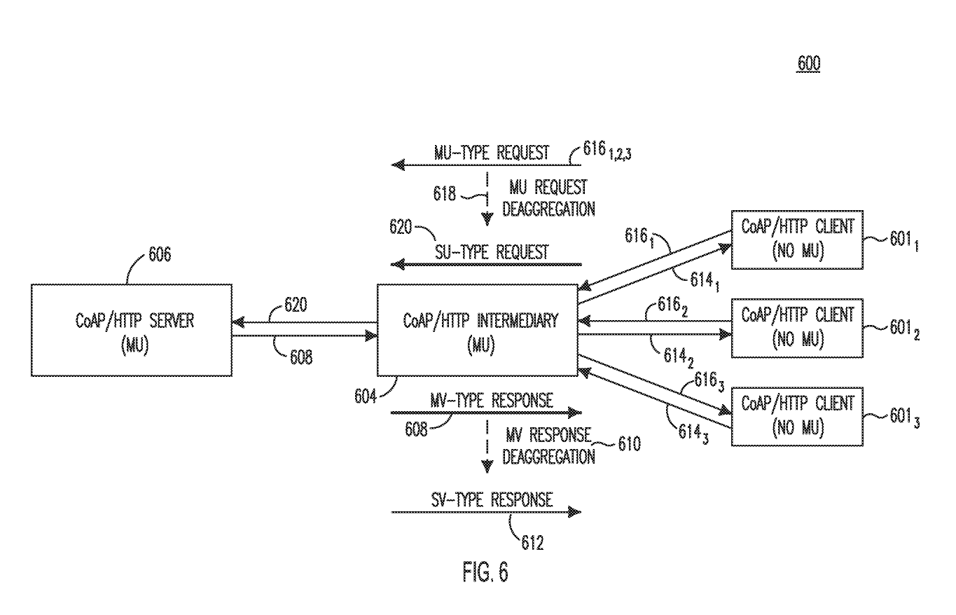

According to another embodiment, the CoAP/HTTP Intermediary may deaggregate an MV-type response message to multiple SV-type response messages. FIG. 6 shows an example of an M2M architecture 600 employing SU request aggregation and MV response deaggregation at a CoAP/HTTP Intermediary 604.

The M2M architecture 600 may include multiple CoAP/HTTP clients 602_{1,2,3}, a CoAP/HTTP server 606, and a CoAP/HTTP intermediary 604. In this example, the CoAP/HTTP server 606 may support MU, but the CoAP/HTTP clients 602_{1,2,3} may not support MU. The Intermediary 604 may receive 608 an MV-type response from the Server 606, and may deaggregate 610 the received MV-type response to generate 612 one or more SV-type responses and may transmit 614_{1,2,3} the MV-type responses to the respective CoAP/HTTP Clients 602_{1,2,3}. The Intermediary 604 may receive 616_{1,2,3} one or more SU-type request messages from the respective CoAP/HTTP Clients 602_{1,2,3} and may aggregate 618 the SU-type Requests to generate and transmit 620 an MU-type request to the CoAP/HTTP server 606.

FIGS. 5 and 6 both illustrate examples of aggregation of SU-type Requests. Additionally, the MU approach may be used for aggregation in other example scenarios. For example, the MU approach may be used to aggregate SU-type request messages with MU-type request messages, or MU-type request messages with other MU-type request messages, applying the procedures described above.

According to an embodiment, procedures at a CoAP/HTTP client may handle multiple URIs. Examples of a CoAP/HTTP client include, for example, a user, and M2M applications such as emergency services alert center. A CoAP/HTTP client may be a sub-component of an application or an SCL and may enable the application or SCL to issue HTTP/CoAP requests.

In order for a CoAP/HTTP Client to manipulate multiple resources, referred to as r₁, r₂, . . . , rᵢ, on the same CoAP/HTTP Server, the CoAP/HTTP Client may generate an MU-type request message containing multiple URIs which may represent those multiple resources to be manipulated. There may be two cases to consider: (1) the same operation may apply to all resources r₁, r₂, . . . rᵢ, or (2) different operations may apply to two or more of the resources r₁, r₂, . . . , rᵢ.

The MU approach may leverage a URI-Path option in CoAP (or Request-Line option in HTTP) to embed multiple URIs in a single CoAP (or HTTP) request message. If a request message contains one URI-Path/Request-Line Option, in order to support multiple URIs, the URI-Path Option in CoAP (or Request-Line Option in HTTP) may be modified to support embedding multiple URIs in one URI-Path/Request-Line Option. If a request message already contains multiple URI-Path/Request-Line Options, then each URI-Path/Request-Line Option may contain a respective URI. In this latter approach, the existing URI-Path/Request-Line Option may be re-used. A URI-Path/Request Line option may be a field within a HTTP/CoAP request message, and may hold a URI address of the target of the HTTP/CoAP request (e.g. cnn.com).

The CoAP/HTTP Client may receive MV-type or SV-type response messages from the CoAP/HTTP Server. If the received responses are SV-type, CoAP/HTTP procedures may be used. In addition, if the SV-type response corresponds to an MU-type request message, a “Token” option may be included in an SV-type response message in order to map the value in the SV-type response message to a correct URI previously contained in the MU-type request message. If the received response message from the CoAP/HTTP server are SV-type, the CoAP/HTTP Client may decode the payload, if present, of the MV-type response message, and recover the contained values and relate each value to a corresponding URI.

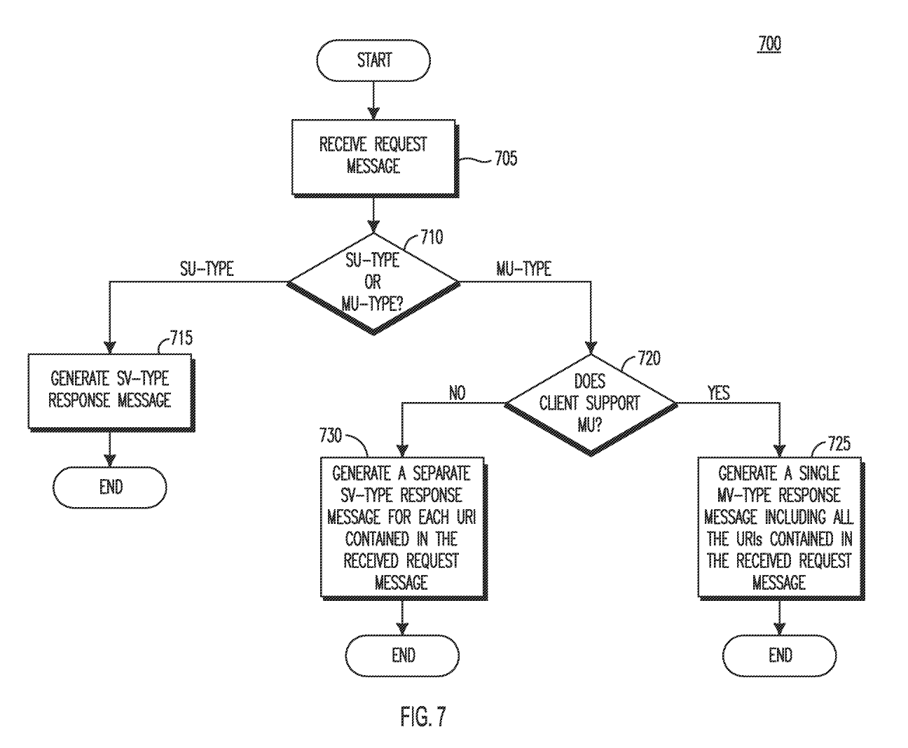

According to another embodiment, procedures at a CoAP/HTTP server may handle multiple URIs. FIG. 7 shows a flow diagram for a procedure 700 for handling multiple URIs at a server. The server may receive a request message, 705. The server determines if the received request message is MU-type or SU-type, 710. If it is SU-type, the server may generate a SV-type response message, 715, using for example CoAP/HTTP procedures. If it is MU-type, the server may generate either SV-type MV-type response(s) based on whether or not the intended client(s) supports MU, 720. Note that if the request message is MU-type, each URI contained in the MU-type message may be decoded properly.

If MU is not supported at the client (or is not desired), a separate SV-type response message may be generated for each URI contained in the MU-type request message, 730. If MU is supported at the client, a single MV-type response message may be generated including all URIs contained in the MU-type request message, 725. The multiple values contained in the payload of an MV-type response message may be made to be distinguishable, as discussed further below.

The CoAP/HTTP intermediary node as described above is especially useful if either the CoAP/HTTP client or CoAP/HTTP server do no support MU. If both the CoAP/HTTP Client and Server support MU, the CoAP/HTTP Intermediary may or may not be used. If only CoAP/HTTP Client (or Server) support MU, the CoAP/HTTP Intermediary may be used to translate between MU and SU CoAP/HTTP in a transparent way, so that the CoAP/HTTP Client and Server may communicate with each other even though one of them does not support MU.

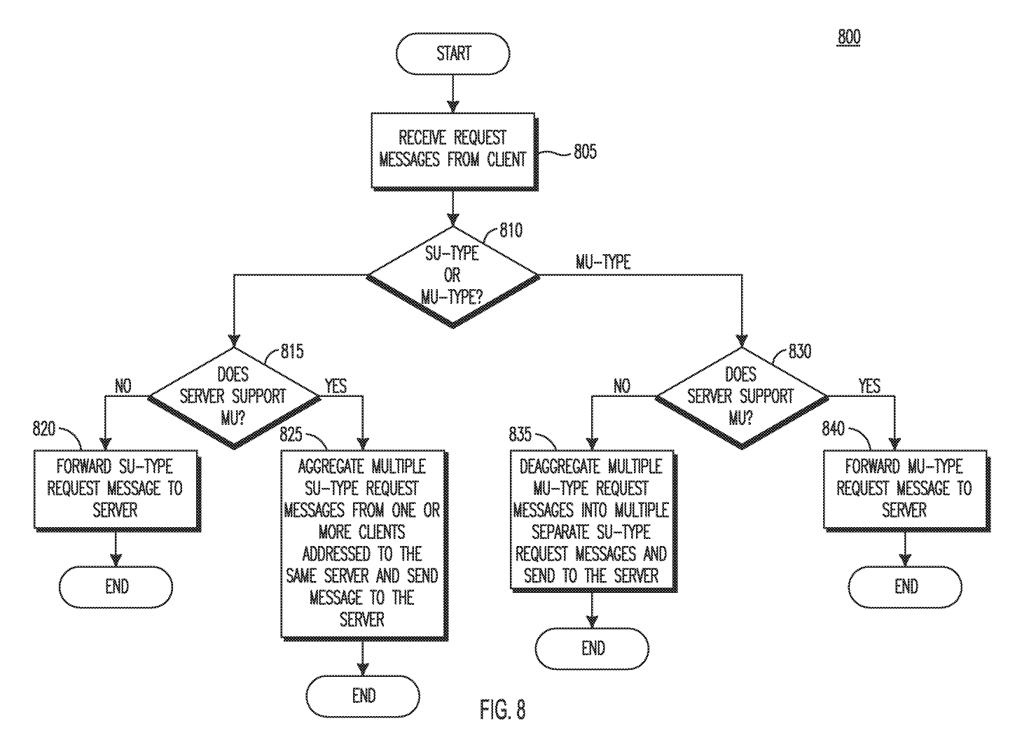

FIG. 8 shows a flow diagram for a procedure 800 for handling multiple URIs at an intermediary. The CoAP/HTTP Intermediary may receive request message(s) from the CoAP/HTTP Client, 805, and may determine if the request message(s) is MU-type or SU-type, 810.

If the request message is SU-type, the server may determine if the server supports MU, 815. If the CoAP/HTTP Server does not support MU, the intermediary may forward the SU-type request message to the CoAP/HTTP server, 820. If the CoAP/HTTP Server does support MU, the CoAP/HTTP Intermediary may use the MU mechanism to aggregate multiple SU-type request messages from one or more CoAP/HTTP Clients addressed to the same CoAP/HTTP Server to generate an MU-type message and send it to the server, 825.

If the request message is MU-type, the server may determine if the server supports MU, 830. If the CoAP/HTTP Server does not support MU, the CoAP/HTTP Intermediary may deaggregate the MU-type request message into multiple separate SU-type request messages and send them to the server, 835. If the CoAP/HTTP Server does support MU, the MU-type request message may be forwarded by the CoAP/HTTP intermediary to the server, 840.

The CoAP/HTTP intermediary may silently receive response messages from the CoAP/HTTP sServer, which may be SV-type or MV-type. For SV-type response messages, if the CoAP/HTTP client does not support MU, SV-type response messages may be forwarded to the client via the CoAP/HTTP intermediary. If the CoAP/HTTP server does support MU, the CoAP/HTTP intermediary may use MU mechanism to aggregate multiple SV-type response messages into an MV-type response message or simply forward the SV-type messages to the CoAP/HTTP Client.

For MV-type response messages, if the CoAP/HTTP client supports MU, MV-type response messages may be forwarded by the CoAP/HTTP Intermediary to the client. If the CoAP/HTTP server does not support MU, the CoAP/HTTP Intermediary may use MU mechanism to deaggregate the MV-type response messages to generate multiple SV-type response messages.

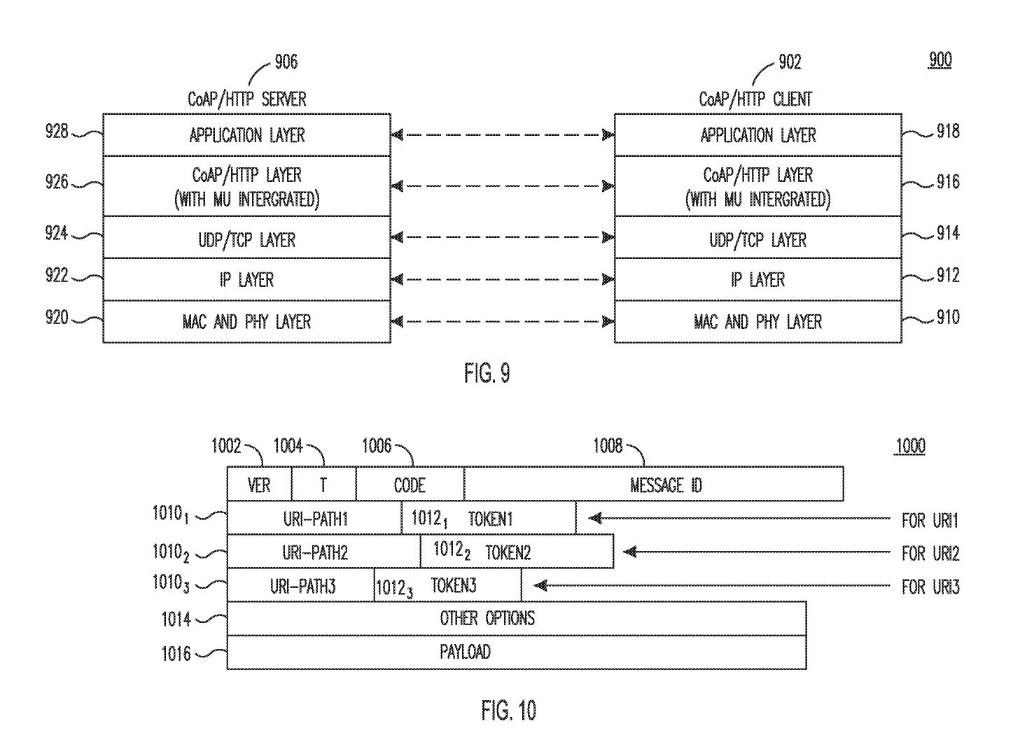

MU techniques, as described above, may be integrated into CoAP/HTTP layer as a part of CoAP/HTTP protocol. In integration with CoAP/HTTP layer, certain modifications may be introduced into CoAP/HTTP protocol to support MU and in turn improve the performance of CoAP/HTTP protocol for M2M applications. FIG. 9 shows an example of a CoAP/HTTP protocol stack 900 including MU integration. The protocol stack for the CoAp/HTTP client 902 may include MAC and physical (PHY) layers 910, an IP layer 912, a UDP/TCP layer 914, a CoAP/HTTP layer 916, and an application layer 918. The MU functionality may be integrated into the CoAPP/HTTP layer 916. Similarly, the protocol stack for the CoAp/HTTP server 906 may include MAC and physical PHY layers 920, an IP layer 922, a UDP/TCP layer 924, a CoAP/HTTP layer 926, and an application layer 928. The MU functionality may be integrated into the CoAPP/HTTP layer 926. Although not shown, a similar protocol stack may be implemented in a CoAP/HTTP intermediary.

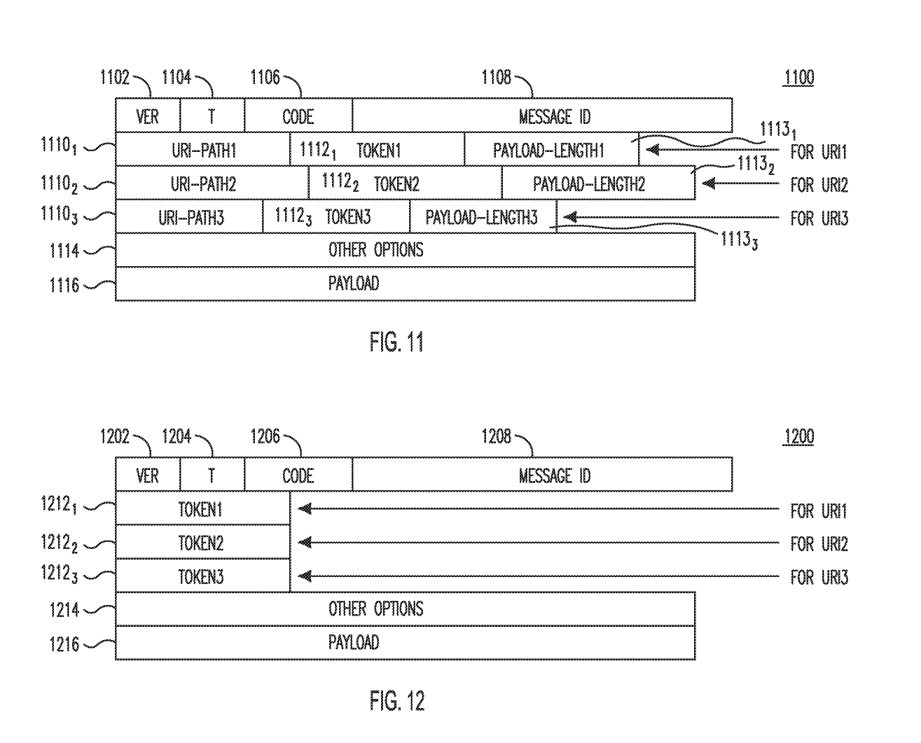

MU-type request messages including multiple URIs may be generated according to the example formats shown in FIGS. 10 and 11 for CoAP. Although examples are shown for CoAP, similar message formats may be used for HTTP or other protocols.

FIG. 10 shows an example of an MU-type CoAP request message 1000 in an MU first format. FIG. 11 is an example MU-type CoAP request message 1100 in an MU second format. In both the examples, multiple pairs of URI-Path and Token options may be used, such that each pair may correspond to a single URI. In the examples, three URIs are assumed for illustrative purposes although any number of URIs may be supported. Examples of values for the fields shown in FIGS. 10 and 11, including ver, code, token, T, message ID, URI path, other options, and payload, are given in Tables 2 and 3 below.

With reference to FIG. 10, the ver field 1002 may be used to indicate if the message is MU-enabled. For example, the default value of the ver field 1002 may be 1 to indicate CoAP and 2 may be used to indicate MU-enabled CoAP. The T field 1004 may assume the CoAP value and when there are multiple URIs each URI may be assumed to have the same T field 1004 value.

The code field 1006 may assume the CoAP value and when there are multiple URIs each URI may be assumed to have the same code field 1006 value. In an example, an extra 8-bit may be introduced in each token field 1012_{1,2,3} to stand for a specific code for each URI.

The Message ID 1008 it may assume the CoAP value. However, the message ID field 1008 may contain a new value generated at the node where the aggregation of messages is conducted. The node may need to maintain a mapping between old message IDs and a new message ID in order to process MU-responses at a later time.

The URI-path fields 10101,2,3, may assume CoAP values and each URI path field 10101,2,3 is associated with a corresponding URI to be included in the message. As explained above, if each URI has different a Representational State Transfer (REST)ful method (i.e. code), an extra 8-bit may be introduced in each URI-Path option 10101,2,3 to contain an original code for each URI.

The token fields 10121,2,3, may assume CoAP values. If each URI has a different RESTful method (i.e. code), an extra 8-bit may be used in each token field or option 10121,2,3. A token option 10121,2,3 may be put after each URI-Path option 10101,2,3 such that the pair options represents a corresponding URI.

Other options 1114 may assume the CoAP values. If an option is used in a CoAP message for a single URI, then multiple such options may be used in an MV-type message, one for each URI.

A single CoAP payload 1016 may include multiple (e.g. three in this example) URI values, which may be delimited in different scenarios. In a first example scenario, there may be no payload for all URIs. For example, the code 1006 for all URIs may be GET or DELETE.

In another example scenario, each URI may need a payload 1016, but the payload 1016 for each URI may be identical. For example, several resources may be updated using the same new value.

In another example scenario, each URI may need a payload 1016, but the payload 1016 for each URI may be different. For example, several resources may be updated using different new value for each resource. If the media type for each resource is an extensible markup language (XML) (or JavaScript Object Notation (JSON)), the XML (or JSON) semantics may be leveraged to self-delimit each value in the payload field 1016.

FIG. 11 is an example MU-type CoAP request message 1100 in an MU second format. Each field ver 1102, T 1104, code 1106, message 1108, URI-Path 1110_{1,2,3}, token 1112_{1,2,3}, other options 1114 and payload 1116 are as described in FIG. 10. If the media type for each resource is other type, an extra payload-length option 1113_{1,2,3} may be included in the CoAP request message 1100 for each resource (or URI). For example, the payload-length option may be set to 1 byte to represent a payload 1116 value up to 255 bytes.

In FIGS. 10 and 11 above, header options may be grouped for each URI and may not appear one after another according to their type. According to another approach, all URI-path options may appear first, followed by all token options, and all payload-length options.

FIG. 12 shows an example of an MV-type CoAP response message 1200 in an MU first format. FIG. 13 shows an example of an MV-type CoAP response message 1300 in an MU second format. The MV-type response message may contain multiple token options, where each token may correspond to a URI.

With reference to FIG. 12, the fields ver 1202, T 1204, code 1206 and message ID 1208 are described as in FIG. 10.

The token option 1212_{1,2,3}, may assume CoAP values. If each URI has a different response code, an extra 8-bits may be used in each token option 1212_{1,2,3}. The extra 8-bits may allow an independent RESTful method (GET, PUT, POST, DELETE) to be affiliated with each URI in the request.

The other options 1214 may assume CoAP values. In other words, if an option is needed in the CoAP for a single URI, then multiple such options may be used in the MV-type message 1200, one for each URI.

Multiple URI values may be included and delimited in payload field 1216. In an example scenario, no payload is included for all URIs. For example, the cod 1206 for all URIs may be PUT/POST. In another example scenario, each URI may need a payload, but the payload for each URI may be different. For example, several resources may be updated using different new value for each resource. If the media type for each resource is XML (or JSON), the XML (or JSON) semantics may be leveraged to self-delimit each value in the payload field 1216. The fields of FIG. 13, including ver 1302, T 1304, cod 1306, message ID 1308, token 1310_{1,2,3}, other options 1314 and payload 1316 are the same as in FIG. 12. Additionally, if the media type for each resource is other type, an extra payload-length option 1313_{1,2,3} may be included in the MV-type message 1300 to be defined for each resource (or URI). The payload-length option 1313_{1,2,3} may be set to 1 Byte to represent a payload 1316 of up to 255 bytes.

In FIG. 13, header options may be grouped for each URI and may not appear one after another according to their type. According to another approach, all token options 1310_{1,2,3} may appear first in the MV-type CoAP response message, followed by all payload-length options 1313_{1,2,3}.

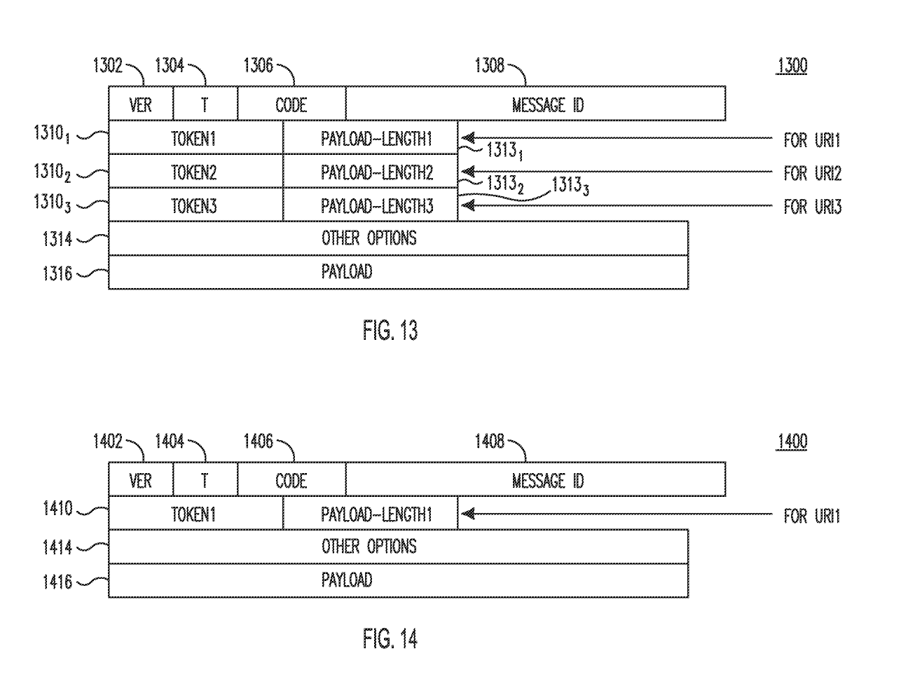

Instead of generating an MV-type response messages, the CoAP Server may issue multiple SV-type response messages in response to a received MU-type request message from the CoAP Client. FIG. 14 shows an example of an SV-type CoAP response message 1400 generated from an MU-type request message, which may have the same format as a CoAP response message. When a server receives an MU-type request message, it may transmit an acknowledge message (ACK) back for the MU-type request which has the same message ID as the MU-type request. Then the server may send individual SV-type response messages, such as response message 1400. Each response message 1400 may include a ver field 1402, T field 1404, a code field 1406, a message ID field 1408, a token option 1410, other options 1414 and payload 1416 (see description of these fields in FIG. 10). Each response message 1400 may have its own unique message ID 1408, which may be different from the message ID of the MU-type request message. Hence, these SV-type response messages 1400 may be non-piggybacked responses to the MU-type request.

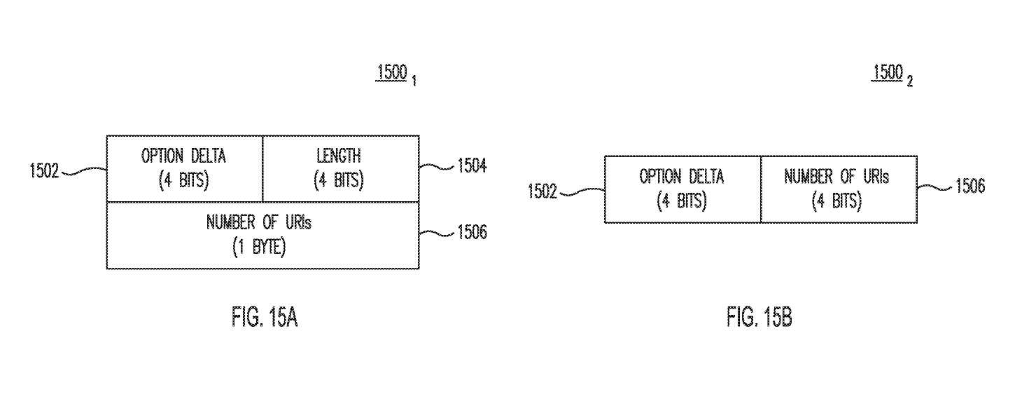

As discussed above, the ver field in the CoAP header may indicate if the CoAP request and response messages support MU or not. According to another embodiment, a CoAP option, referred to as the MU option, may be used to indicate MU. FIGS. 15A and 15B show example formats for an MU option 1500_{1,2}, respectively. Example fields are shown in FIGS. 15A and 15B, although other fields not shown may be included.

FIG. 15A shows an example of a standard format of an MU option 1500₁. In the standard format, an option delta field 1502 (e.g. 4 bits long) and a length field 1504 (e.g. 4 bits long) may be included. A number of URIs field 1506 may indicate the number of URIs that are contained in the request and response messages. The number of URIs field 1506 may be, for example, one byte long. FIG. 15B shows an example of a compact format of an MU option 1500₂. A compact format may be designed such that the number of URIs field 1506 may be represented by fewer, for example 4 bits for a maximum of 16 URIs. Additionally, a length field may be omitted to reduce the size of the MU option 1500₂ further.

Some examples of implementing the MU option are given in the following; however, other implementations may be used. According to an example, the MU option, such as that illustrated in FIGS. 15A and 15B, may be placed at the beginning of all other CoAP header options. In this case, the option number for the MU option may be the minimum. However, the small CoAP option numbers may be already allocated by the CoAP specification. In an example, the CoAP option number allocation may be adjusted and a small number may be reallocated to MU options. For example, “1” may be allocated for the MU option or the MU option may be placed immediately after the content-type option. According to another approach the option delta (option delta 1502 shown in FIG. 15A) may be set to a negative value so that the MU option, even with a big option number, may still appear in front of other CoAP header options.

In the following, examples are given for implementing an MU approach in HTTP. An HTTP request message may include some header fields such as “Request-Line”, while other header fields such as “Status-Line” may appear in the HTTP response messages. “Request Line” may be contained in a HTTP request message, and may include several parameters or fields including, for example, method token (e.g. “Token”), “Request-URI” and the protocol version (e.g. “ver”). “Status-Line” may be contained in a HTTP response message, and may include the protocol version (e.g. “ver”), a numeric status code (e.g “Code”) and an associated textual phrase.

According to an embodiment, an MU-type HTTP request message may use a “Request-Line” field used to contain “Request-URI” in order to support an MU-type request. According to a first approach, multiple “Request-URI” may be embedded in the “Request-Line” field. For example, if containing n URI, the “Request-Line” format may be changed to Request-Line=Method+Request-URI(1)+Request-URI(2)+ . . . +Request-URI(n)+HTTP-Version, where it is assumed that “Method” for each “Request-URI” is the same. In another example, if containing n URI, the “Request-Line” format may be changed to Request-Line=Method(1)+Request-URI(1)+Method(2)+Request-URI(2)+ . . . +Method(n)+Request-URI(n)+HTTP-Version, assuming “Method” for each “Request-URI” is different. According to another embodiment, the “Request-Line” field may be kept unchanged, but multiple “Request-Line” fields may be embedded in the header of a HTTP request message.

An HTTP response message may be modified to an MV-type HTTP response message. In order to contain the results for multiple “Request-URI”, the following changes may be made to HTTP response message to create new MV-type HTTP response messages. According to an embodiment, the HTTP response Header Fields may be modified such that multiple “Status Code” and “Reason-Phrase” values may be embedded in the “Status-Line” field of the response message header. For example, the “Status-Line” format may be changed to: Status-Line=HTTP-Version+Status-Code(1)+Status-Code(2)+ . . . +Status-Code(n)+Reason-Phrase(1)+Reason-Phrase(2)+ . . . +Reason-Phrase(n), or Status-Line=HTTP-Version+Status-Code (1)+Reason-Phrase(1)+Status-Code(2)+Reason-Phrase(2)+ . . . +Status-Code(n)+Reason-Phrase(n). Here, “Status-Code(n)” may be the status code for “Request-URI(n)”, and “Reason-Phrase(n)” may stand for the status text for “Request-URI(n).” According to another embodiment, the HTTP response payload may be modified to contain multiple values or representation, such that each value or representation may be the result for each “Request-URI”.

In the following, example deployments are given for MU implementations for use, for example, with the capabilities of a CoAP/HTTP client and server.

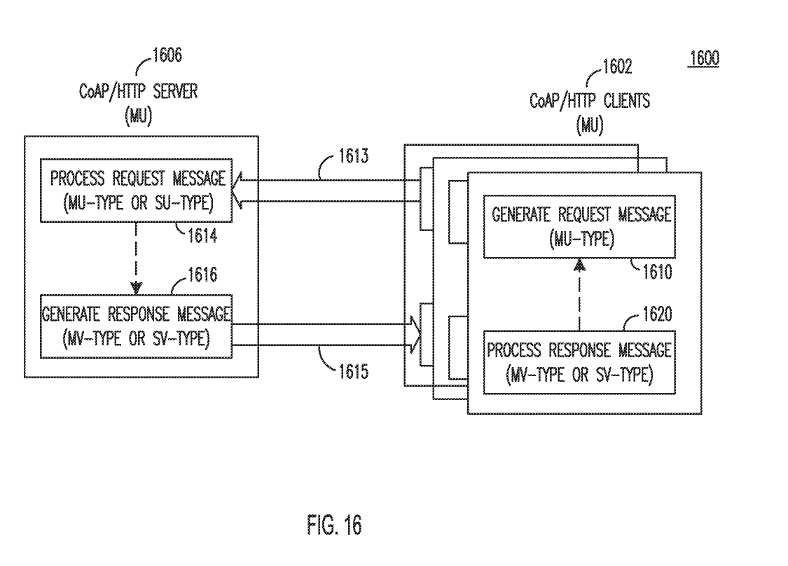

FIG. 16 is an example of an M2M architecture 1600 where both the CoAP/HTTP client(s) 1602 and server 1606 support MU. In this example, no intermediary is shown, however, an intermediary may or may not be used. The CoAP/HTTP clients 1602 may generate 1610 MU-type request message(s) and transmit 1613 to the CoAP/HTTP server 1606. The server 1606 may process 1614 the MU-type message and may generate 1616 an MV-type or multiple SV-type responses. The server 1606 may transmit 1615 the response messages to the clients 1602.

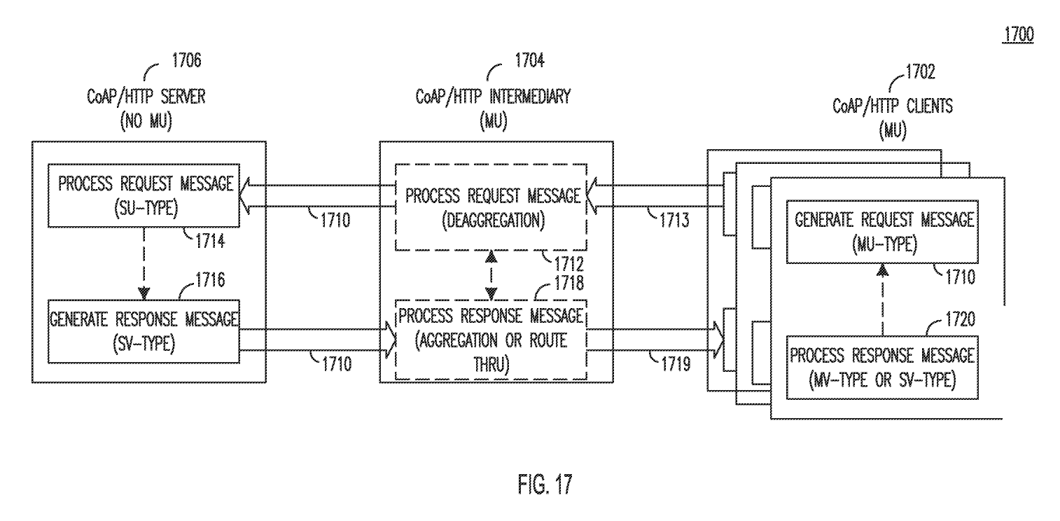

FIG. 17 is an example of an M2M architecture 1700 where the CoAP/HTTP client(s) 1702 supports MU and CoAP/HTTP server 1706 does not support MU, employing an CoAP/HTTP Intermediary 1704. The CoAP/HTTP client(s) 1702 may generate 1710 an MU-type request message(s) and transmit 1713 it to the intermediary 1704. The intermediary 1704 may process 1712 the request message, which may include deaggregating the request message to generate SU-type request messages, and may send the SU-type request messages to the server 1706. The server 1706 may process 1714 the SU-type request messages and generate 1716 an SV-type response message. The intermediary 1704 may receive 1717 and process 1718 multiple SV-type response messages received from one or more servers 1706. Such processing 1718 may include aggregating response messages to generate an MV-type response message. The MV-type and/or SV-type response message may be sent 1719 to the client 1702 for processing 1720.

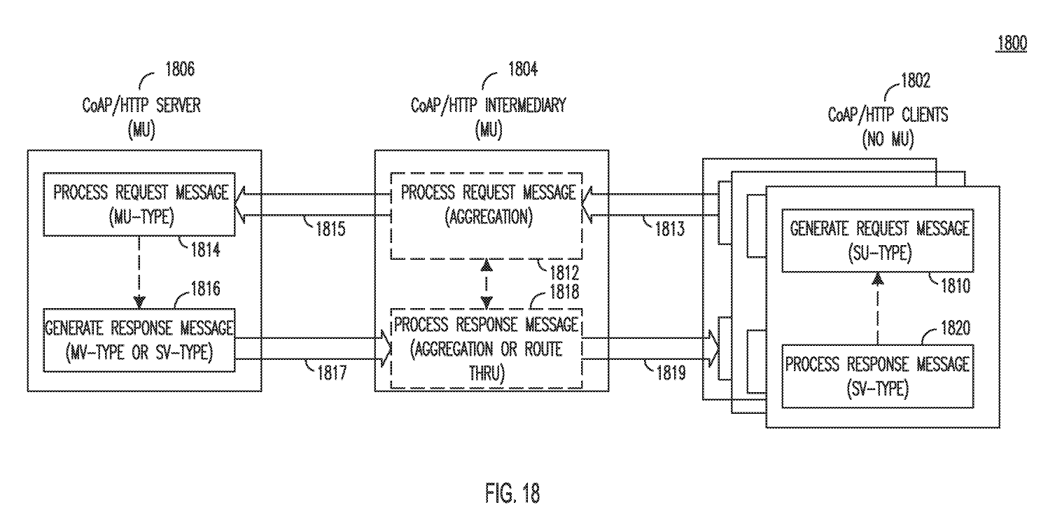

FIG. 18 is an example of an M2M architecture 1800 where the CoAP/HTTP client(s) 1802 does not support MU and the CoAP/HTTP server 1806 supports MU, employing an CoAP/HTTP Intermediary 1804. Each CoAP/HTTP client(s) 1802 may generate 1810 an SU-type request message and transmit 1813 the request to the CoAP/HTTP intermediary 1804. The CoAP/HTTP intermediary 1804 may process 1812 the request messages, which may include aggregating multiple SU-type request messages to generate an MU-type request message, and may send 1815 the MU-type request message to the server 1806. The server 1806 may process 1814 the MU-type request message and generate 1816 SV-type or MV-type response messages. The intermediary 1804 may receive 1817 and process 1818 the SV-type and/or MV-type response messages received from the server 1806. Such processing 1818 may include deaggregating MV-type response messages to generate multiple SV-type response messages. The SV-type response messages may be sent 1819 to the client 1802 for processing 1820.

The MU techniques described above may be used to retrieve multiple resources in one message. Table 1 illustrates an MU-type request message, which may be generated by a CoAP client. The header may include a “GET” request, and header field values are given for the T, code and message ID (MID) fields.

The example MU-type request message of table 1 may show the following information: it is a CoAP “GET” request message; the message needs confirmation from the CoAP server (i.e. T=CON); it is a MU-type request message (i.e. Code=1); the ID of this message is 0×6789 (i.e. MID=0×6789); the message contains three URIs (i.e. Uri-Path1, Uri-Path2, and Uri-Path3); there are three tokens for each URI respectively (i.e. 20 for Uri-Path1, 21 for Uri-Path 2, 22 for Uri-Path 3).

TABLE 1
MU-Type Request Message

Header: GET (T=CON, Code=1, MID=0x6789)
Uri-Path1: “temperature”Uri-Path2: “pressure”
Uri-Path3: “smoke”
Token1: 0x20
Token2: 0x21Token3:0x22

In response to receiving the MU-type message, the CoAP Server may generate an MV-type response message. Two examples of MV-type response messages are given in Tables 2 and 3.

TABLE 2
MV-Type Response Message (with the same response code, text-
formatted payload)

Header: GET (T=ACK, Code=69, MID=0x7d35)
Token1: 0x20Token2: 0x21
Token3:0x22
Payload-Length1:10
Payload-Length2:10Payload-Length3:10
Payload: “22.30 C″″10.5″″11.6”

TABLE 3
MV-Type Response Message (with different response code; xml-
formatted payload)

Header: GET (T=ACK, Code=0x00, MID=0x7d35)
Code1: 69
Code2:132
Code3:69
Token1: 0x20Token2: 0x21Token3:0x22Payload:
<?xml version=“1.0” encoding=“UTF-8” ?>
<value>
“22.30 C”
</value>
<?xml version=“1.0” encoding=“UTF-8” ?>
<value>
”11.6”
</value>

The example message in Table 2 may show the following information: it is a CoAP response message for GET request message (i.e. T=ACK); the ID of this message is 0×7d35 (MID=0×7d35); the response code is 69 (i.e. Code=69), which implies this code is the same for all 3 Uri-Paths and there is a payload contained in this message; there are three tokens equivalent to those 3 tokens in the request message in Table 1; and there are three Payload-Length values (i.e. 10 bytes) and three values in the payload for each Uri-Path as contained in the request message shown in Table 1.

The example message in Table 3 may show the following information: it is a CoAP response message for GET request message (i.e. T=ACK); the ID of this message is 0×7d35 (MID=0×7d35); the response code is different for each Uri-Path in Table 1 since code=0×00; Code1 is for Uri-Path1 in Table 1 and it (i.e. Code1=69) means there is a value in the payload for Uri-Path1; Code2 is for Uri-Path2 in Table 1 and it (i.e. Code2=132) means Uri-Path2 is not found in the CoAP sever; Code3 is for Uri-Path3 in Table 1 and it (i.e. Code1=69) means there is a value in the payload for Uri-Path3; there are three tokens equivalent to those 3 tokens in the request message in Table 1; and there are 2 values in the Payload for Uri-Path1 and Uri-Path3 respectively.

In the following, the performance of MU approaches is analyzed. For convenience of performance analysis, the following symbols are defined. OH₁₂ may be the overhead from MAC/PHY frame header and preamble. OH₃₄ may be the overhead from IP header and UDP/TCP header. OH_{req} may be the overhead in CoAP request message from normal CoAP message header and options. OHᵣₛₚ may be the overhead in CoAP response message from normal CoAP message header and options. OH_{reqnew} may be the overhead from using MU to the request message. OH_{rspnew} may be the overhead from using MU to the response message. M may be the number of URIs in an MU request message. H may be the number of hops between the Client and Server. L_{pld} may be the payload size for each URI. It may be assumed that L_{pld} is identical for all URIs. L_{req} may be the size of a request message. Lᵣₛₚ may be the size of a response message. T may be the total traffic caused including those forwarded at intermediate nodes. U may be transmission utility defined as the ratio of total payload over total traffic caused.

According to a first example, a Client may issue a GET method to retrieve the value of M(>1) resources on the Server. A “Piggy-backed” response may be assumed.

Using CoAP without MU, M request messages and M response messages may be transmitted between the Client and the Server. The total traffic (T_{coap}) introduced in the network may be calculated as follows:

$${T}_{coap} = H * M * ( {L}_{reg} + {L}_{rsp} ) = H * M * [ ( {OH}_{12} + {OH}_{34} + {OH}_{req} ) + ( {OH}_{12} + {OH}_{34} + {OH}_{rsp} + {L}_{pld} ) ] \qquad Equation 1$$

The transmission utility (U_{coap}) may be calculated as follows:

$${U}_{coap} = \frac{M * {L}_{pld}}{{T}_{coap}} = \frac{{L}_{pld}}{H * [ \begin{matrix}( {OH}_{12} + {OH}_{34} + {OH}_{req} ) + \\ ( {OH}_{12} + {OH}_{34} + {OH}_{rsp} + {L}_{pld} )\end{matrix} ]} \qquad Equation 2$$

Likewise, the total traffic Tₘᵤ and transmission utility Uₘᵤ under MU may be calculated as follows:

$$\begin{matrix}{T}_{mu} = H * [ ( {OH}_{12} + {OH}_{34} + {OH}_{req} ) + ( {OH}_{12} + {OH}_{34} + {OH}_{rsp} + M * {L}_{pld} + M + M ) ] \\ {U}_{mu} = \frac{M * {L}_{pld}}{{T}_{ommu}} & Equation 3 \\ = \frac{M * {L}_{pld}}{H * [ \begin{matrix}( {OH}_{12} + {OH}_{34} + {OH}_{req} ) + \\ ( {OH}_{12} + {OH}_{34} + {OH}_{rsp} + M * {L}_{pld} + M + M )\end{matrix} ]} & Equation 4\end{matrix}$$

In Equations 3 and 4, an extra 1-Byte “Payload-Length” option and an extra 1-Byte “Code” for each URI may be taken into consideration.

The ration of equations 2 and 4 is as follows:

$$\frac{{U}_{coap}}{{U}_{mu}} = \frac{\begin{matrix}\{ \begin{matrix}( {OH}_{12} + {OH}_{34} + {OH}_{req} ) + \\ ( {OH}_{12} + {OH}_{34} + {OH}_{rsp} + {L}_{pld} )\end{matrix} \} + \\ 2 M + \{ ( M - 1 ) * {L}_{pld} \}\end{matrix}}{M * \{ \begin{matrix}( {OH}_{12} + {OH}_{34} + {OH}_{req} ) + \\ ( {OH}_{12} + {OH}_{34} + {OH}_{rsp} + {L}_{pld} )\end{matrix} \}} < 1 \qquad Equation 5$$

Given that the ratio is less than 1, it may be concluded from Equation 5 that MU can achieve higher utility than CoAP without MU by using multiple URIs.

For example, IEEE 802.15.4 has OH₁₂=15 bytes and IEEE 802.11 Direct-Sequence Spread Spectrum (DSSS) has OH₁₂=48 bytes. In addition, the total overhead from IPv6 and UDP is OH₃₄=48 bytes, which may be compressed to OH₃₄=3 bytes according to 6LoWPAN header compression. Based on CoAP specification, OH_{req}=7 bytes and OHᵣₛₚ=7 bytes, assuming use URI-Path=2 bytes and Token=1 byte only.

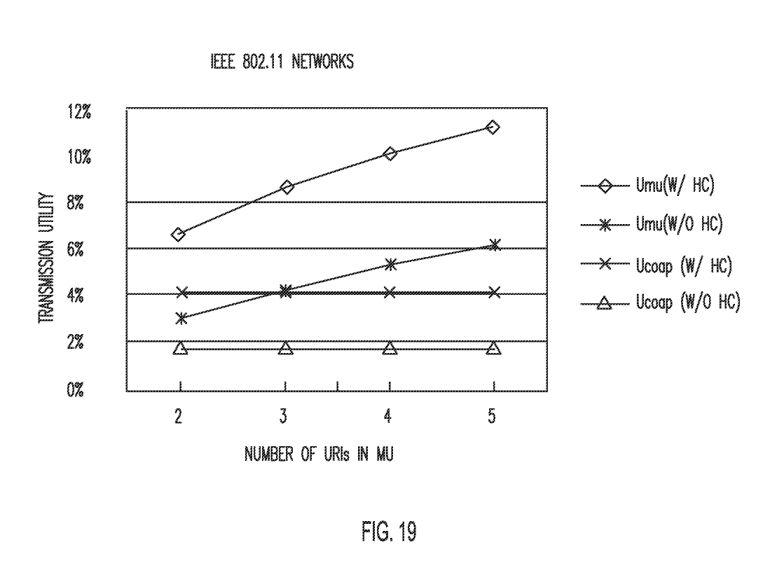

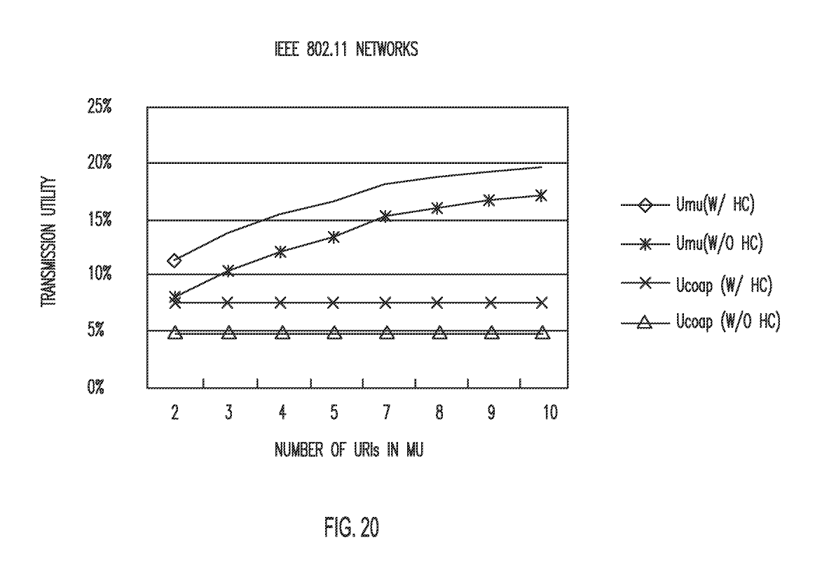

FIGS. 19 and 20 show transmission utility values versus number of URIs for 802.15.4 and 802.11 networks, respectively. The transmission utility values shown include the transmission utility of CoAP employing MU Uₘᵤ with and without header compression (W/ HC and W/O HC). The transmission utility values shown also include the transmission utility of CoAP (without MU) U_{coap} with and without header compression (W/ HC and W/O HC). In the example of FIG. 19, OH₁₂=15 bytes, H=4, and L_{pld}=10 bytes. FIG. 19 includes header compression. In the example of FIG. 20, OH₁₂=48 bytes, H=4, and L_{pld}=50 bytes. The results in FIGS. 19 and 20 demonstrate that MU can achieve higher transmission utility than CoAP without MU, and that improvement in transmission utility increases with the number of URIs (M).

The MU approaches described above may be used under security considerations. For example, in contrast to HTTP (over port 80), HTTP secure (HTTPS) protocol may use port 443 and may run over Transport Layer Security/Secure Socket Layer (TLS/SSL) protocol to provide secure communications. TLS/SSL, as a layer below HTTP, may provide HTTP a secure connection, such that HTTPS may operate as HTTP over TLS/SSL. TLS/SSL may use two-way handshaking procedures to establish the secure connection. HTTPS may transport normal HTTP request/response messages over this secure connection. As a result, the existence of TLS/SSL may not prevent the use of multiple URI in HTTP messages.

Any of the following techniques may be used to leverage TLS/SSL more efficiently. According to one embodiment, in a Client-to-Server solution, multiple URIs which may have the same security requirements and access control may be included in the same HTTP message.

According to another embodiment, in a “Multiple Clients”-to-“Intermediary”-to-“Server” solution, the intermediary may use multiple client certificates to establish secure connections with the Server. Alternatively, the server may pre-assign a special client certificate to the intermediary based on multiple client certificates. This special client certificate may be used by the intermediary's TLS/SSL to set up a special connection with the Server for multiple URI operations such as aggregation and de-aggregation.

According to another embodiment, in a “Client”-to-“Intermediary”-to-“Multiple Servers” solution, the intermediary may use multiple server certificates to establish secure connections with the Client. Alternatively, the intermediary may calculate a special server certificate based on multiple server certificates. The special server certificate may be used by the intermediary's TLS/SSL to set up a special connection with the Client for multiple URI operations such as aggregation and de-aggregation as discussed above.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for performing machine-to-machine (M2M) communications performed by an M2M device, the method comprising:
receiving, at the M2M device from an M2M application, a multiple Universal Resource Identifier (MU)-type request message including a plurality of URIs associated with a plurality of corresponding resources at the M2M device;
decoding each of the plurality of URIs; and
generating at least one response message including a plurality of values in a payload corresponding to the plurality of resources.

2. The method of claim 1, wherein the at least one response message includes a multiple value (MV)-type response message.

3. The method of claim 1, wherein the at least one response message includes a plurality of single value (SV)-type response messages, wherein each of the plurality of SV-type response messages includes a value for a different resource.

4. The method of claim 1, wherein the received MU-type request message includes at least one URI associated with a resource at a different M2M device.

5. The method of claim 1, wherein the M2M device communicates with the M2M application via an M2M gateway.

6. A method for performing machine-to-machine (M2M) communications performed by an M2M application, the method comprising:
generating a multiple Universal Resource Identifier (MU)-type request message to access resources at an M2M device, wherein the MU-type request message includes a plurality of Universal Resource Identifiers (URIs) corresponding to a plurality of resources at the M2M device;
transmitting the MU-type request message to the M2M device; and
receiving at least one response message, from the M2M device, including a plurality of a values in a payload corresponding to the plurality of resources.

7. The method of claim 6, wherein the at least one response message is a multiple value (MV)-type response message.

8. The method of claim 6, wherein the at least one response message is a plurality of single value (SV)-type response messages, each of the plurality of SV-type response messages including a value for a different resource.

9. The method of claim 6, wherein the MU-type request message includes at least one URI associated with a resource at a different M2M device.

10. The method of claim 6, wherein the M2M device communicates with the M2M application via an M2M gateway.

11. A method for performing machine-to-machine (M2M) communications performed by an M2M intermediary, the method comprising:
receiving, at the M2M intermediary, a plurality of single Universal Resource Identifier (SU)-type request messages from a M2M client;
aggregating, at the intermediary, the plurality of SU-type request messages to generate a multiple Universal Resource Identifier (MU)-type request message including a plurality of Universal Resource Identifiers (URIs) extracted from the plurality of SU-type request messages; and
transmitting the MU-type request message to a M2M server.

12. The method of claim 11 further comprising:
receiving a multiple value (MV)-type response message from the M2M server, the MV-type response message including a plurality of a values in a payload corresponding to the plurality of resources;
deaggregating the MV-type response message and generating a plurality of single value (SV)-type response messages, each of the plurality of SV-type response messages including a value from the plurality of values corresponding to a different resource; and
transmitting the plurality of SV-type response messages to the M2M client.

13. The method of 12 further comprising:
generating at least one MV-type response message from the received MV-type response message; and
transmitting the at least one MV-type response message to the M2M client.

14. The method of claim 11 wherein the M2M intermediary, M2M client, and M2M server operate using at least one of a Constrained Application Protocol (CoAP) and a Hypertext Transfer Protocol (HTTP).

15. A method for performing machine-to-machine (M2M) communications performed by an M2M intermediary, the method comprising:
receiving, at the M2M intermediary, a multiple Universal Resource Identifier (SU)-type request message from a M2M client;
deaggregating, at the intermediary, the MU-type request message to generate a plurality of single Universal Resource Identifier (SU)-type request messages, each of the plurality of SU-type request messages including a single Universal Resource Identifier (URI) extracted from the MU-type of request message; and
transmitting the plurality of SU-type request messages to a M2M server.

16. The method of claim 15 further comprising:
receiving a plurality of single value (SV)-type response messages from the M2M server, the plurality of SV-type response messages each including in a payload a corresponding value from a plurality of a values corresponding to the plurality of resources;
aggregating the SV-type response messages to generate a multiple value (MV)-type response message including the plurality of values corresponding to the plurality of resources; and
transmitting the MV-type response message to the M2M client.

17. The method of 16 further comprising:
generating at least one SV-type response message from the received plurality of SV-type response messages; and
transmitting the at least one SV-type response message to the M2M client.

18. The method of claim 15 wherein the M2M intermediary, M2M client, and M2M server operate using at least one of a Constrained Application Protocol (CoAP) and a Hypertext Transfer Protocol (HTTP).
